(19) United States
(12) Patent Application Publication
(10) Pub. No.: US 2017/0140380 A1
(43) Pub. Date: May 18, 2017

(54) A System for Money Remittance and Method Thereof

(71) Applicant: NUMONI PTE LTD, Singapore (SG)

(72) Inventors: SENG CHUAN TAN, SINGAPORE (SG); MENG LYE SIT, SINGAPORE (SG)

(21) Appl. No.: 15/316,166

(22) PCT Filed: Jun. 5, 2015
(86) PCT No.: PCT/SG15/50143

§ 371 Date: Dec. 3, 2016

(30) Foreign Application Priority Data
Jun. 4, 2014 (SG) 10201402922P

(51) Int. Cl. G06Q 20/40; G06Q 20/10; G06Q 20/18

(52) U.S. Cl. CPC G06Q 20/4014; G06Q 20/18; G06Q 20/10

(57) ABSTRACT

The present invention provides a system for transferring funds comprising: a first terminal (100) connected to a communication network for a sender to initiate a fund transaction; a second terminal (100) linked to the communication network allowing a recipient to interactively respond to the fund transaction; a plurality of servers (400) connected to the communication network, the servers (400) include a database that stores sender and recipient's information, and further incorporate a visual and/or audio application to enable a visual and/or audio communication between the first and the second terminal (100, 200); and a third party entity server (500) connected to the plurality of servers (400) via the communication network, the third party entity server (500) manages the sender's account, the recipient's account and the fund transaction; wherein the servers (400) are configured: to receive information of the sender and the recipient from the first terminal (100), to authenticate the identity of the sender and recipient by comparing the received information with that stored in the database, to facilitate a visual and/or audio channel between the first terminal (100) and the second terminal (200) via the visual and/or audio application to establish the visual and/or audio communication, to receive transaction information from the first terminal (100), and to transmit the received information together with an instruction to the third party entity server (500) to transfer the corresponding funds from the sender's account to the recipient's account; characterised in that the visual and/or audio application complements the servers (400) to enable the sender and the recipient to authenticate their identities and confirm the transaction information during the fund transaction.

### FIELD OF INVENTION

The present invention relates to a micro-financing service. More particularly, the present invention relates to a system and method for transferring funds with fully automated identity recognition and validation.

### BACKGROUND OF THE INVENTION

With the increasing number of migrants in different countries around the world, the need for communication between the migrants and their friends and family in their home country is rising. Due to several reasons, the migrants may find that communicating internationally by phone is the best option. Nevertheless, the cost of international calls can he overwhelming especially when they want to remit funds hack home. When remitting funds, during or after the transaction of fund, the sender may desire to communicate with the recipient in order to obtain acknowledgement. Furthermore, the communication between a sender and a recipient allows the sender or the recipient to verify each other. Such verification is crucial and useful for those who do not have a bank account or for those who change mobile phone numbers frequently. However, existing money remittance systems do not simultaneously provide a real-time transaction and face-to-face video call for the sender and the recipient to communicate with each other via the video call during the transaction.

There are a few patented technologies over the prior arts relating to the abovementioned system. Of interest in respect to a method and system for remitting money is PCT Patent No. WO2013065985A3. This patent provides a method and system for remitting money using only the name and mobile phone number of the recipient, and enabling the remitted money to be immediately drawn from a parent account at the time when the remitter remits the money regardless of whether or not the recipient is a member. Accordingly, the remitter can immediately remit money without the concern of an account balance change which can occur between the time of remittance by the remitter and the time of receipt of the money by the non-member recipient, and the remitted money can be transferred to the recipient at the desired time.

Another invention which relates to the method and system for money remittance is disclosed in PCT Patent No. WO2002057978A1. The patent discloses a remittance management system for managing or instructing remittance so that the costs of money transfer between banks to the client and banks may be lowered. When a sender client remits money from the account of the sender client to the account of a recipient client, the sender client transfers the money to an account, not remitting it. When the system confirms the transfer, the system transfers money, not from the account, but from the account to the account. The balance of the account is supplemented by transfer or debt by the system. Integration of transactions and a change of cash flow are conducted while check of cost tradeoff is being made.

The prior arts are mainly focused on the transaction of such system but not on the user experience and authentication. Therefore, there is a need to have an interactive kiosk which allows the users to interactively communicate with their family members or friends while transferring funds. The present invention provides such a system and method thereof.

### SUMMARY OF INVENTION

Accordingly, it is a primary object of the present invention to provide a system and a method for facilitating the transaction of by receiving the funds from a sender and disbursing the funds to a recipient via a first and a second terminal. The funds or representation of values may be in the form of digital currency, crypto-currency, voucher, cash, air-time credit, bitcoin, and etc.

It is another object of the present invention to provide a system and method for remittance transaction supported with fully automated identification recognitions and validations.

It is another object of the present invention to provide an interactive kiosk system that is able to establish streaming based end-to-end video call between the kiosk terminal and appropriate mobile phone or computing device allowing the users of the system to communicate during the fund transaction process.

It is yet another object of the present invention to provide a system and method for transferring funds to recipient where the sender and the recipient do not possess bank accounts.

The invention discloses a system for money remittance, the system comprises a first terminal connected to a communication network for a sender to initiate a remittance transaction to transfer funds from an account of the sender to a recipient; a second terminal linked to the communication network allowing the recipient to interactively respond to the remittance transaction; a plurality of servers connected to the communication network, configured to facilitate a visual and/or audio channel from the first terminal to the second terminal allowing a face-to-face video call to be established between the terminals, receive and transmit the sender's information, recipient information, and transaction information to a corresponding third party entity through the communication network to disburse the funds to the recipient account;

Preferably, when the sender initiates a remittance transaction at the first terminal, the servers establishes a visual and/or audio channel from the first terminal to the second terminal allowing a face-to-face video call to begin upon the recipient accepting the video call, and followed by the servers receiving transaction information from the first terminal and a confirmation of the transaction information from the second terminal, and then the servers transmit the information to the a corresponding financial entity for transferring the funds from the sender account to the recipient account.

One skilled in the art will readily appreciate that the invention is well adapted to carry out the objects and obtain the ends and advantages mentioned, as well as those inherent therein. The embodiments described herein are not intended as limitations on the scope of the invention.

### BRIEF DESCRIPTION OF THE DRAWINGS

For the purpose of facilitating an understanding of the invention, there is illustrated in the accompanying drawing the preferred embodiments from an inspection of which when considered in connection with the following description, the invention, its construction and operation and many of its advantages would be readily understood and appreciated.

FIG. 1 is a schematic diagram of a system for money remittance, in accordance to the preferred embodiment of the invention.

### DETAILED DESCRIPTION OF THE INVENTION

Hereinafter, the present invention shall be described according to the preferred embodiments of the present invention and by referring to the accompanying description and drawings. However, it is to be understood that limiting the description to the preferred embodiments of the invention and to the drawings is merely to facilitate discussion of the present invention and it is envisioned that those skilled in the art may devise various modifications without departing from the scope of the appended claim.

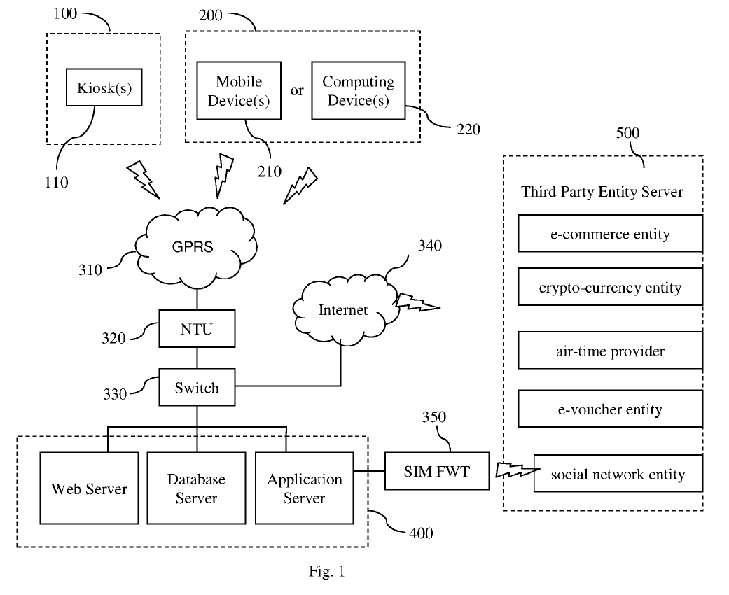

For the convenience of description, a person who donates or transfers funds shall be referred as a “sender” while the person who receives the funds shall be referred as a “recipient”. However, the sender and recipient may also be institutions, corporations, or companies. Preferably, the present invention caters to transfer funds from an individual to the recipient. Referring to FIG. 1, a system for money remittance is shown according to the preferred embodiment of the invention. The system comprises a sender who uses a first terminal (100), a recipient who uses a second terminal (200), a plurality of servers (400) connected to the terminals (100, 200) and a third party entity server (500) enabling the sender to securely transfer fund from the sender account to the recipient account.

In a preferred embodiment of the invention, the sender at a first terminal (100) first initiates a remittance transaction to transfer funds from a corresponding account of the sender to a recipient at the second terminal (200). Upon receiving the instruction and information from the first terminal (100), the servers (400) facilitates a visual and/or audio channel from the first terminal (100) to the second terminal (200) allowing a face-to-face video call to be established between the terminals (100, 200) when the recipient accepts the video call. Then, the sender is prompted to insert transaction information and the recipient confirms the information. The information together with sender and recipient details will then be sent to the third party entity server (500) for transferring the funds from the sender account to the recipient account.

In the preferred embodiment of the invention, the first terminal (100) is an interactive kiosk (110) which may be strategically placed in shopping complexes, malls, merchants' stores, or mass transit stations etc, configured to receive and dispense cash, receive instruction and information from the user of the kiosk (110), display a list of options allowing the user to choose a desired service, and trigger the face-to-face video call. The kiosk terminal (110) comprises means for establishing the face-to-face video call such as display units, cameras, speakers, and microphone. It should not be limited to the described example as any means for beginning a video call is applicable to the system. Also, the kiosk terminal (110) may comprise a note and coin acceptor unit for receiving notes and coins as a means of payment. Furthermore, a module may incorporate with the note and coin acceptor unit to identify the notes and coins. In addition, the kiosk terminal (110) may further comprise a card reader and sensor for detecting payment using cards with security chip or magnetic stripe such as reward cards, point cards, stored-value cards, gift cards, credit cards or debit cards. The kiosk (110) has a hopper to store the notes and coins. In the event of the collection of the notes and coins, a unique unlocking code or mechanism needs to be provided to the kiosk (110) in order to remove the hopper. The hopper may be provided with a sensor to measure the contained cash for safety and verification purposes. It should be noted that the mode of payment is not limited to the aforementioned examples and may be varied and improved in accordance to the progression of payment technology in the future. The kiosk (110) may also provide means for printing the transaction receipt or c-voucher.

The kiosk terminal (110) may further comprise a plurality of buttons to allow the user to select the options displayed by at least one display screen. However, the buttons may not be required if the display screens are touch screens or other input/output devices. During the money remittance, the user is prompted to select and insert information. The information may include but is not limited to a preferred language of the interface, mobile numbers and names of the sender and the recipient, the value of remittance, the type of device which may be used to receive the fund, a Personal Identification Number (PIN), an account number, identification card number, and etc.

In one embodiment of the invention, the kiosk terminal (110) may comprise a near field communication (NFC) reader which allows the kiosk terminal (110) to establish connection between the kiosk and mobile device having NFC chips. The NFC allows the kiosk terminal (110) to directly deduct mobile airtime credit or mobile wallet points from the mobile device to be used as a means of payment. Furthermore, the NFC also allows the kiosk terminal (110) to identify and verify a user by scanning the mobile phone owned by the user. Once the identity of the user is verified, the transaction of fund from the user account can then be transferred. Alternatively, biometric identification means such as fingerprint recognition, retina scan or face recognition may also be utilised in addition to the identity card number or mobile phone number. When biometric identifications are used, the kiosk terminal (110) is provided with a fingerprint scanner, retina scanner or a camera with face recognition software.

In another embodiment of the invention, the first (100) or the second terminal (200) can be a kiosk terminal (110) as described above, a computing device (200), or a mobile device (220) such as personal digital assistants (PDA), smart phones, tablet, laptops, netbooks and etc. If the first (100) or the second terminal (200) is a computing device (210) or a mobile device (220), an appropriate program or application is installed in the device to allow the terminals (100, 200) to begin a face-to-face video call and confirm the value of funds which are to be received. Moreover, the application or program comprises a graphical user interface allowing users to select the options. The application can be a web-based application, mobile application, or software. The application or program may further comprise Face recognition or audio recognition software to verify the recipient. Furthermore, the second terminal is able to receive text message, picture message or in combination thereof via appropriate receiving means.

In one embodiment of the invention, the connection between the first terminal (100), second terminal (200) and the servers (400) is established via a communication network linked to a network termination unit (NTU) (320). The link between the network and the NTU (320) may be established through a wired or wireless connection. Preferably, the communication network is a wireless network connection established via a wireless protocol cloud, which is a GPRS cloud (310). However, it is obvious to a person skilled in the art that to substitute the technology with other wireless protocols and standards such as Code Division Multiple Access (CDMA) and its derivatives, Enhanced Data Rates for GSM Evolution (EDGE), 3G protocol, High Speed Packet Access (HSPA), 3GPP Long Term Evolution (LTE) and the like, in accordance to the advancement of wireless technology with time. Alternatively, the NTU (320) is connected to a network switch (330). The network switch (330) allows the network to be either connected to the servers (400), to an Internet cloud (340) or both.

In the preferred embodiment of the invention, the servers (400) comprise a web server, a database server and an application server. The received information from both the terminals (100, 200) is stored in the database server. The web server may host a money remittance website. The application server coordinates the transaction between sender and third party entity to transfer funds from the sender to the recipient. A currency converter module may also be installed within the application server and is made applicable for an international transaction. The currency converter module maintains a currency exchange rate that is determined by the third party entity (500) and may change accordingly under the fluctuation of the currency exchange rate.

In addition, the application server also establishes a visual and/or audio channel from the first terminal (100) to the second terminal (200), the plurality of servers connect the first and the second terminals (100, 200) via the communication network allowing the face-to-face video call to be established between the terminals (100, 200) upon receiving confirmation to begin the video call from the second terminals (200). For example, the application server establishes its communication routes through a peer-to-peer topology built on the proprietary protocol. Nevertheless, any protocol for bi-directional transfer of video data between the first and the second terminals (100, 200) is feasible in the system. In another embodiment of the invention, a third party video application such as Skype, Tango, Facetime, Facebook, and etc may be connected to the servers (400) to provide the visual and/or audio communication. The third party video application may comprise add-on buttons for facilitating fund transaction. In one embodiment of the invention, the remittance and video process can be entirely or partly executed within the third party video application.

The third party entity (500) is a body that handles and manages the transaction of funds. The third party entity (500) may be an e-commerce entity, an airtime provider, an e-voucher entity, a digital currency or crypto-currency entity such as BITCOIN, or even a social network entity whose virtual credit is exchangeable for money, goods, or services. In one embodiment of the invention, the third party entity may be owned by the system operator. In the preferred embodiment of the invention, the servers (400) communicate with the third party entity servers (500) via the communication network instructing the third party entity server (500) to execute the transaction and notify the servers (400). In one embodiment of the invention, the operator of the system may hold a system account, whereby the system firstly disburses a sum of predetermined fund into the system account allowing the third party entity (500) to directly deduct the transferred value of funds from system account upon receiving instruction from the servers (400).

The system account is important when the system involves a transaction of cash at the kiosk terminal. When a sender disburses cash as a fund or payment into the kiosk, the servers (400) may instruct the third party entity server (500) to transfer the corresponding value of fund from the system account to the sender account, whereas when a recipient request to receive the fund in form of cash, the servers (400) may instruct the third party entity server (500) to transfer the corresponding value of fund from the recipient account to the system account, then the servers (400) further instructs the kiosk to disburses the corresponding value of cash to the recipient.

The second terminal (200) may be a computing device (210) or a mobile device (220). Initially, the remittance transaction is activated by the sender through selecting the money remittance option at the kiosk terminal (110) and inserting the mobile phone account number, PIN number, and recipient information. The servers (400), upon receiving information from the kiosk terminal (110), check if the recipient is available to begin a face-to-face video session and establish a visual and/or audio channel. If the recipient is online, the servers (400) transmit a message to the recipient to notify the recipient and request a confirmation from the recipient to start the video session. Not only does the establishment of the video session serve as identity recognition, it also allows the sender and recipient to interactively communicate with each other.

During the video session, the servers (400) prompt the sender to insert the value for remittance and request the recipient to confirm the value of funds. Then, the servers (400) send the money remittance request in form of information packet containing the sender information, the recipient information, and the transaction information to the third party entity server (500). When the third party entity server (500) receives the request from the servers (400), the third party entity server (500) transfers corresponding funds from the sender account to the recipient account, and further sends a transaction status in the form of a response code to the servers (400). The servers (400) may further send the transaction status to the sender and recipient via a short message (SMS), an email, or any other appropriate means.

In one aspect of the invention, the second terminal (200) is the kiosk terminal (110) allowing the recipient to directly withdraw the funds in form of cash from the recipient's account via the kiosk terminal (110). The recipient may firstly select a fund withdrawal option from a designated third party entity account and insert the account number, identification PIN and value of fund to be withdrawn. Upon receiving the request, the servers (400) send a verification code to the recipient prompting the recipient to insert the verification code. Then, the servers (400) instruct the third party entity server (500) to transfer the funds from the recipient account to the system account. Upon receiving the fund from the recipient account, the servers (400) instruct the kiosk terminal (110) to dispense the corresponding value of funds in form of cash to the recipient. The recipient is also able to transform the funds into electronic voucher, goods, or services via the kiosk (110). The server (400) may further send a receipt bearing a special transaction ID or pass-codes allowing the recipient to go to a counter or cash out station for receiving the funds in form of cash, vouchers, goods, or services.

The recipient may initiate a transaction through the kiosk terminal (110) and establish a video session to the sender's mobile device. In this embodiment of the invention, the sender may be prompted to accept the video call. After accepting the video call, the sender may select payment transfer options such as electronic wallet, e-voucher, or any suitable online transfer method. In addition, a service station of the system can he provided to receive physical cash, voucher, goods, or services from the sender as a payment means.

In another aspect of the invention, when the first and the second terminals (100, 200) are kiosk terminals (110) as described in previous paragraphs, the recipient may insert the sender mobile phone number into the kiosk (110), after which the servers (400) send a PIN representing the address of the corresponding kiosk (110) to the sender's mobile phone, the sender inserts the PIN to establish the video session between the two terminals (100, 200).

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the invention.

1.-20. (canceled)

21. A system for transferring funds, comprising:
a first kiosk terminal connected to a communication network for a sender to initiate a fund transaction and to collect the funds in a form of cash from the sender;
a second kiosk terminal linked to the communication network allowing a recipient to interactively respond to the fund transaction and to dispense the transacted funds in the form of cash to a recipient;
a plurality of servers connected to the communication network, the plurality of servers including a database that stores sender and recipient information, and further incorporates a visual or audio application to enable a visual or audio communication between the first and the second terminal; and
a third party entity server connected to the plurality of servers via the communication network, the third party entity server managing a sender account, a recipient account and the fund transaction;
wherein the plurality of servers are configured:
to receive information of the sender and the recipient from the first terminal, to authenticate the identity of the sender and recipient by comparing the received information with that stored in the database,
to facilitate a visual or audio channel between the first terminal and the second terminal via the visual or audio application to establish the visual or audio communication,
to receive information relating to the transaction and funds collected from the first terminal,
to transmit the received information together with an instruction to the third party entity server to transfer the corresponding funds digitally from the sender's account to the recipient's account, and
to instruct the second terminal to dispense the funds in the form of cash upon receiving instruction from the second terminal;
wherein the visual or audio application complements the plurality of servers to enable the sender and the recipient to authenticate their identities and confirm the transaction information during a fund transaction and the recipient can receive the funds in the form of cash in real time from the second terminal.

22. The system according to claim 21, further comprising a currency convertor module to convert the currency of the funds to a designated foreign currency.

23. The system according to claim 21, wherein the third party entity server sends a transaction record to the plurality of servers after the completion of transaction and the plurality of servers forward the transaction record to the terminals.

24. The system according to claim 21, wherein the first kiosk terminal and second kiosk terminal comprise:
a cash acceptor for receiving cash from the sender;
a display screen to display a video call and a plurality of transaction options; a speaker;
a camera; and
a microphone and means for inputting instruction and information.

25. The system according to claim 24, wherein the first and second kiosk terminals further comprise:
a processor;
a module containing options for the sender to select;
a module for calculating the received cash and the cash to be dispensed;
means for connecting the kiosk terminal to the communication network; means for printing the transaction record;
a card reader and sensor for detecting cards with security chips, paper vouchers and tickets; and
a biometrics device and sensor for detecting biometric information of the sender including fingerprints, voice recognition, face recognition, hand geometry, and iris recognition.

26. The system according to claim 24, wherein the first and second kiosk terminals further comprise a near field communication reader which allows each kiosk terminal to establish connection between itself and a mobile device embedded with near field communication chips.

27. The system according to claim 24, wherein the kiosk terminal further comprises a cash dispenser for dispensing the funds in the form of cash.

28. The system according to claim 23, wherein the transaction record bearing a special transaction ID or pass-codes allows the recipient to go to a counter or cash out station for receiving the funds in the form of cash, vouchers, goods, or services.

29. The system according to claim 21, wherein the plurality of servers comprises:
a web server;
a database server for storing the information received from the terminals;
an application server for managing the transaction between the terminals and the third party entity and establishing a video call via a visual or audio application.

30. The system according to claim 21, wherein the recipient is able to initiate a video call over the kiosk terminal to a mobile device of the sender.

31. The system according to claim 21, wherein the third party entity is any one of e-commerce entity, airtime provider, e-voucher entity, digital currency or crypto-currency entity, and social network entity.

32. A method for money remittances, comprising the steps of:
collecting funds in a form of cash from a first kiosk terminal and depositing the collected funds electronically to an account of a sender;
receiving instructions from the sender at the first terminal for establishing a remittance transaction to transfer funds from the account of the sender to a recipient over a second kiosk terminal;
receiving the sender information and a recipient information from the first terminal;
establishing a visual or audio channel from the first terminal to the second terminal by a plurality of servers connecting the first and second terminals via a communication network;
beginning a face-to-face video call over the established channel upon receiving confirmation from the second terminal;
receiving transaction information from the first terminal and confirmation of the transaction information from the second terminal;
transmitting the transaction information together with the sender information and the recipient information to a corresponding third party entity for disbursing the funds to the recipient account; and
instructing the second terminal to dispense the funds in the form of cash to the recipient upon receiving a request from the recipient.

33. The method according to claim 32, further comprising the step of:
sending a verification PIN to the recipient for the recipient to conduct a self-verification over the second terminal before receiving the funds in form of cash therefrom.

34. The method according to claim 32, further comprising the step of:
converting the currency of the funds to a designated foreign currency via a currency convertor module.

35. The method according to claim 32, further comprising the step of:
prompting the sender to select a preferred language.
